(19) United States
(12) Patent Application Publication
(10) Pub. No.: US 2013/0219983 A1
(43) Pub. Date: Aug. 29, 2013

(54) RHEOMETER STANDARDISATION

(71) Applicant: Alan George, Lancashire (GB)

(72) Inventor: Alan George, Lancashire (GB)

(21) Appl. No.: 13/882,618

(22) PCT Filed: Nov. 2, 2011
(86) PCT No.: PCT/GB2011/052135

§ 371 Date: Apr. 30, 2013

(30) Foreign Application Priority Data
Nov. 12, 2010 (GB) 1019146.8

(51) Int. Cl. G01N 11/08

(52) U.S. Cl. CPC G01N 11/08
USPC 73/1.03

(57) ABSTRACT

A rheometer is standardized to a prescribed rheological measurement reference standard by: a so-called ‘Cluster Die’, with one or more die orifices matched to a standard Melt Flow Index Die; an orifice matched to a standard Melt Flow Index Die to produce both a ‘multiplier’ pressure drop and equivalent overall rheological effect; individual or combined regional adjustments; a slow matching taper to conjoin two flow regions with minimal interference of flow pattern or pressure drop; thermometer placement in the body surrounds of a heated die; calibration of a thermometer for die melt temperature by a combination of temporary and permanent placements of other thermometers; a temperature stabilization device for melt pressure transducers of rigid or flexible stem construction; a polymer plant gear pump polymer melt drive adapted for rheometry using internal flow restriction as a rheometer die.

This invention relates to rheology and rheometry. Rheological measurements reflect material (flow) behaviour under processing, such as a relationship between deformation and applied stress or working. A particular, but not exclusive, concern is conformity of rheometric measurement with, and/or replication of, a rheological test standard. So-called ‘Melt Flow Index’ (MFI) is a prime test standard, and thus a target for replication, for which it is desirable to align, conform or standardise a generic rheometer. Adaptation to replicate other rheological tests is also a challenge, especially if to be appropriate for a diversity of test replication by common refinements in rheological apparatus. It is also useful to conduct wider tests alongside and so in relation to MFI.

In rheometers it is known to use so-called replicate dies to emulate a rheological test which have their own prescribed test environment. Some rheometers have adopted multiple replicate dies in an attempt to replicate multiple tests. Hitherto, attempts to achieve replicate dies for an MFI test have been unsatisfactory, so in the rheometer industry MFI has effectively been sidelined. Yet MFI remains a ‘touchstone’ in the spectrum of rheological assessment of complex polymer molecular character and behaviour. It would be very useful for MFI to be one in a spectrum of accessible and meaningful rheological tests and conducted under common conditions, with respective replica dies, so an MFI test emulation can be conducted alongside and related to or contextualised with other tests.

Generally, a die configuration, context, environment, disposition, temperature and pressure conditioning and measurement have a bearing upon material through flow behaviour and rheological measurement. MFI test is a useful consideration in itself and as a contextual anchor for wider rheological testing.

MFI Reference Standard

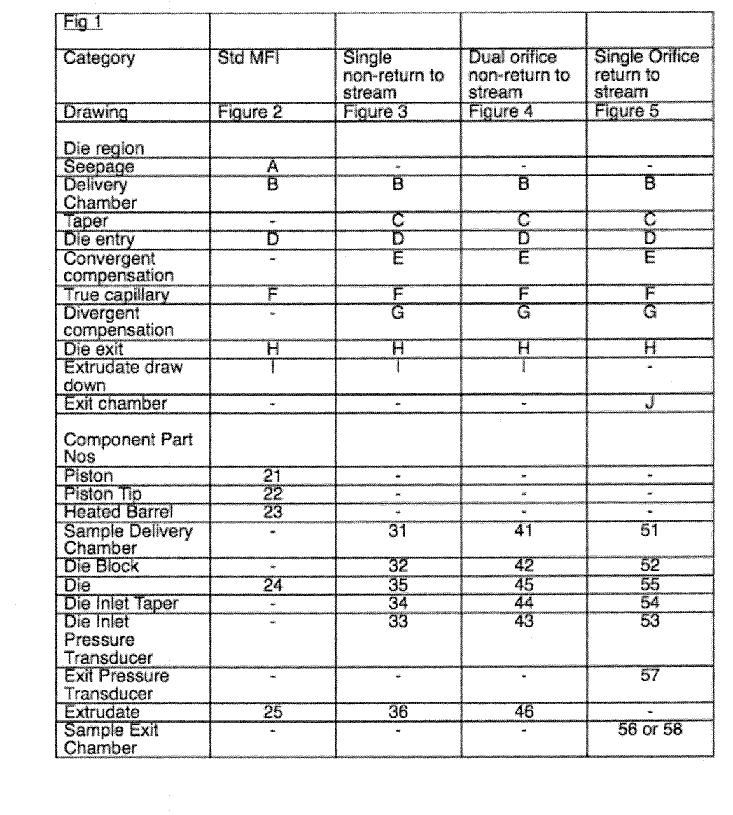

For some sixty years MFI has been a reference standard (of laboratory origins) for bulk polymer, such as polyethylene and polypropylene. MFI is defined as, or expressed in terms of, a flow rate through a standard orifice (g/10 minutes). Equipment and test specifications are laid out in two similar global standards, namely ASTM D 1238 and ISO 1133. FIG. 1 is a simplified cross-section of ‘dedicated’, standard MFI equipment.

MFI is now a repeatable, standardised and precise measurement. MFI is also one the most reliable ways of quantifying Average Molecular Weight or Chain Length. MFI is therefore widely used in process control, often in conjunction with ubiquitous computer control. Quality Assurance (QA) is based upon MFI. MFI testing is typically conducted with dedicated (laboratory or replicate) test equipment, of which a manually-operated, so-called ‘Melt Indexer’ remains a principal measurement tool for polymer manufacturing process control.

Many polymers have complex structures, which could use process controls based upon measurement of Molecular Weight Distribution. So-called ‘Multi-shear’ rheometry addresses this, but currently the measurement is relatively undeveloped and not standardised in relation to an MFI value.

A manually-operated, laboratory-based, rheometer MFI tester has a sample through-put productivity that is far too low for modern high-volume polymer plant. Full robotised versions, based on manual piston-in-bore equipment resolve productivity, but fail on reliability.

However, a traditional gear pump, or rather gear pump driven or fed, rheometer remains a strong contender for automated rheometer MFI measurement. It has potential fast response capability, but requires frequent ‘calibration’, so is confined to lesser roles, such as indicating product change. Its prime potential of real-time, measurement of more complete rheological parameters, is largely ignored, mainly due to an unacceptable variability of results. The traditional design has not generally progressed sufficiently, especially in the faithful replication of the standard MFI test and wider precision rheometric measurement. Various aspects of the invention address this.

Conventionally, the gear pump drives material through a prescribed die restriction in a polymer melt flow pump, but in one aspect of the invention disclosed later, the Applicant has envisaged using the restriction in the gear pump itself, which thus becomes a rheometer or has a rheometer role in addition to other roles in a polymer plant or process control.

Generally, little attention has been paid to understanding how a (dedicated) MFI die works, so that its action can be replicated in new equipment design. Some attention has been paid to the control of polymer melt temperature and the precision measurement of melt pressure, as these parameters play a fundamental part in the make-up of a rheometer/Melt Indexer. The volumetric efficiency of the gear pump has also been studied.

Hitherto, the majority of gear pump analysers have been ‘pure’ rheometers, designed to feed direct from an extruder system. These perform MFI measurement only as a secondary function and it is well-recognised can suffer from large errors, due to uncertainty of measurement and operating conditions; so they can require frequent correction and recalibration, particularly after each product change.

Some other gear pump analysers have been designed for dedicated MFI measurement, notably the proprietary Porpoise P5 and Optical Control Systems OP5. These use a force-fed static melting system to charge a gear pump with molten polymer. A capillary die matches three capillary criteria of MFI apparatus, namely shear rates, shear stress and die L/D ratio.

Configuration to a manufactured product range is by choice of capillary diameter. Thus, say, a 4.2 mm diameter capillary die can be used for a product range between 0.2 and 20 MFI. A repeatability of +/−1% can readily be achieved over a test campaign.

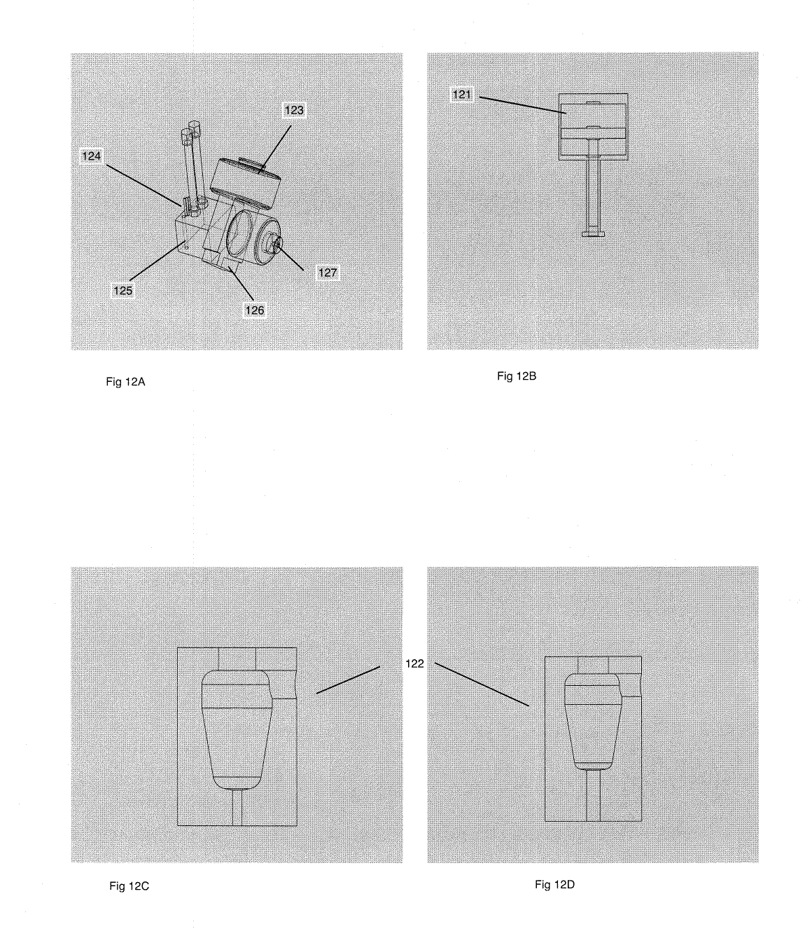

However, the measurement requires an empirical calibration or conversion curve for compliance with the standard MFI test. An example of such a calibration is shown graphically in FIG. 11E. Calibration can be permanent, but is particular to each polymer plant and process. The Standard Error, in comparison with a laboratory MFI test result, can be typically +/−5-7%. ‘Non-conformance’ of a test outcome can lead to ‘first-pass’ rejection of a considerable amount of good material.

A generic rheometer tends to measure under different operating conditions from a Melt Indexer. Thus the die tract(s) of single and dual die rheometers are primarily designed to measure shear viscosity and extensional viscosity. These rheometers normally use ‘non-MFI’, non-MFI-specific or non-dedicated dies, especially in relation to an entry region. All rheometers ‘struggle’ to perform at low MFI measurement, due to a lack accurate measurement techniques. There is a need for good low pressure melt measurement and a means of metering flow at very low flow rates.

### SUMMARY

Conformity, harmonisation and standardisation of a rheometer with a Melt Flow Index (MFI) test is desirable, for effective test replication in non-dedicated test apparatus, such as a rheometer, let alone a multi-test or multi-role rheometer, so the rheometer measurement bears some relation to the standard MFI test, is a prime challenge, which previous attempts have failed to achieve.

A common rheometer through-flow arrangement employs a gear pump to meter a polymer test sample through a test die. The gear pump can intake a feed of molten polymer from an extruder and/or some other melting device, such as a static melter. Another rheometer feed employs a piston to meter polymer through a die, using one or more bores. The standard MFI test itself specifies a certain weighted piston, but generally a rheometer does not match all the test factors, so must emulate or replicate them in its die action. In that regard or to that end, a so-called Twin Bore rheometer has two parallel test chamber bores with respective end dies. Particular attention is given to die¹ profile and disposition in a chamber.

### STATEMENT OF INVENTION

According to one aspect of the invention, a rheometer is aligned with, calibrated or otherwise standardised to a prescribed rheological measurement reference variously by a so-called ‘Cluster Die’, with one or more die orifices, in respective individual die bodies or a common shared die body, matched to a standard Melt Flow Index Die for equivalent rheological effect.

The invention further provides a rheometer with refinement options as reflected in the appended claims, and of which two involve capillary die geometry, vis:
a simple and direct means of more accurate replication of important elements, factors or influences of Melt Flow Index flow conditions;
standardisation, harmonisation or conformity of a so-called ‘multi-shear’ rheometer measurement or test with a Melt Flow Index measurement or test, in a common conditioning environment, to allow test inter-relationship;
precise pressure measurement in a polymer melt, using appropriate sensors such as conventional liquid-filled sensors; reflecting rheometer reliance upon difficult measurement of polymer melt pressure;
gear pump volumetric efficiency improvement at low flow rates;
improved polymer temperature conditioning;

A given rheometric measurement for a range of materials may require a range of different die profiles and dimensions, along with different test chamber through flow rates, and thus a range of gear pump speeds or capacities.

One construction arrangement of rheometer features a so-called ‘replicate’ die profile, configuration, context environment, along with environmental conditioning, such as of temperature and/or pressure, as set out in the appended claims. A set of dies covers a measurement range or spectrum as a replicate group or cluster including an MFI die. Overall, a rheometer, or an isolated rheometer portion or test stream, is standardised to a prescribed rheological measurement reference standard, of which MFI is a prime, but not sole or exclusive example, variously with one or more of the following features:
a so-called ‘Cluster Die’, with one or more die orifices ‘matched’ to a standard Melt Flow Index Die, for equivalent or replicate rheological effect;
an orifice matched to a standard Melt Flow Index Die. to produce both a ‘multiplier’ pressure drop and equivalent overall rheological effect;
individual regional adjustment(s). or combined regional adjustment(s);
a slow, ‘matching’ taper to conjoin two flow regions. with minimal interference of flow pattern or pressure drop;
thermometer placement in the body surrounds of a heated die, to measure die melt temperature;
calibration or cross-referral of a thermometer for die melt temperature by temporary and/or permanent placement of other thermometers in the die melt, in the die and at the heating element(s) of the die;
a temperature stabilisation device for melt pressure transducers of rigid or flexible stem construction, of any type of pressure transducer.

Such refinements are relevant to general rheological test replication. Even those primarily with an MFI agenda can have advantages for other tests. A rheometer can thus feature complementary measurement chamber, internal die disposition, transition pathway, entry and exit profiles, within temperature-conditioned confines and with embedded thermometer and pressure sensor.

With multiple discrete dies, or die orifices in individual or shared die bodies, set within a common conditioning environment, the Applicant envisages the feasibility of different tests conducted in parallel, through respective dies. Test conditions, such as temperature and pressure must be appropriate for each test. Multi-test ‘parallel’ or harmonised outcomes offer a more complete assessment than any individual test, even a prime measure such as MFI, taken in isolation. MFI remains an invaluable part of a wider test spectrum since the other tests can be related to an MFI determination, albeit at each MFI test condition.

Dies set in a common test chamber with a divided or apportioned sample streams could have an interactive effect upon flows, but if this is taken into account, could be used for parallel tests. Alternatively, test chamber sub-division, with dedicated sub-chambers for each die, offers isolated tests in a common conditioned environment, in an enshrouding die block with attendant heaters, temperature and pressure sensors.

The potential contribution of such a rheometric advance is significant to improved plant efficiency in polymer manufacturing industry for better process control working to the known standard, in turn producing better product quality, towards an ideal of making a desired product, instead of a random product. Downstream secondary producers also have a more defined specification basis upon which to set their own processes.

In a compact configuration, a temperature and pressure conditioned die block and pump body are interconnected or integrated, to present a continuous flow path for a polymer melt through-stream between pump intake and die output.

As reflected in FIGS. 12A through 12D, and to achieve the performance depicted graphically in FIG. 11 sequences, a so-called (displacement pressure or force) ‘intensifier’ is employed to force polymer into a measurement head, where it is melted, with pressure exerted being controlled by air pressure upon a larger piston head relative to a smaller polymer displacement piston.

A thermal jacket is disposed around a plurality, such as two, of silicon-on-sapphire pressure transducers, to minimise thermal effects upon temperature compensation resistors; these substitute for heat pipe stabilisation measures.

Of three temperature sensors fitted, two are used to detect liquid polymer temperature in a die capillary, from established relationships found experimentally with a probe in a capillary (subsequently removed); a third sensor being used for die temperature control.

A diverter valve in a die block is used to direct polymer to either of two dies. An auxiliary heater zone removes an otherwise cold spot in heating system. A gear pump input shaft is available for a motorised drive, such as a pulsed action stepper motor.

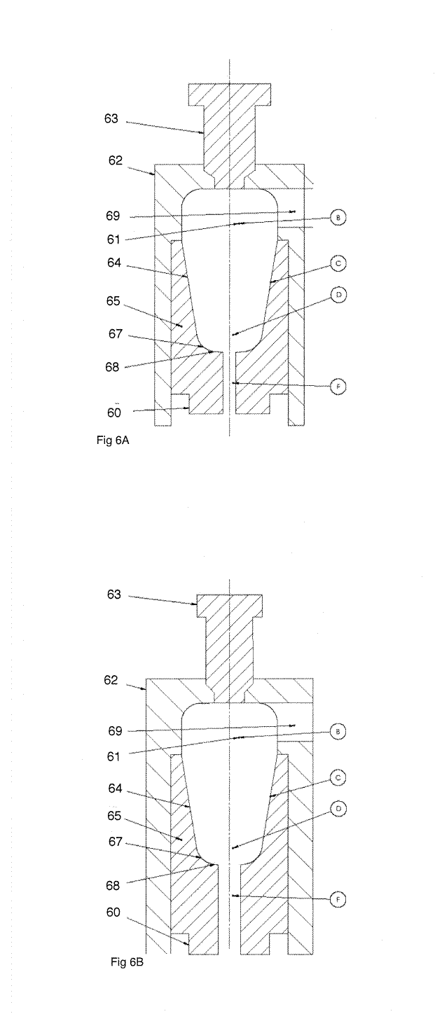

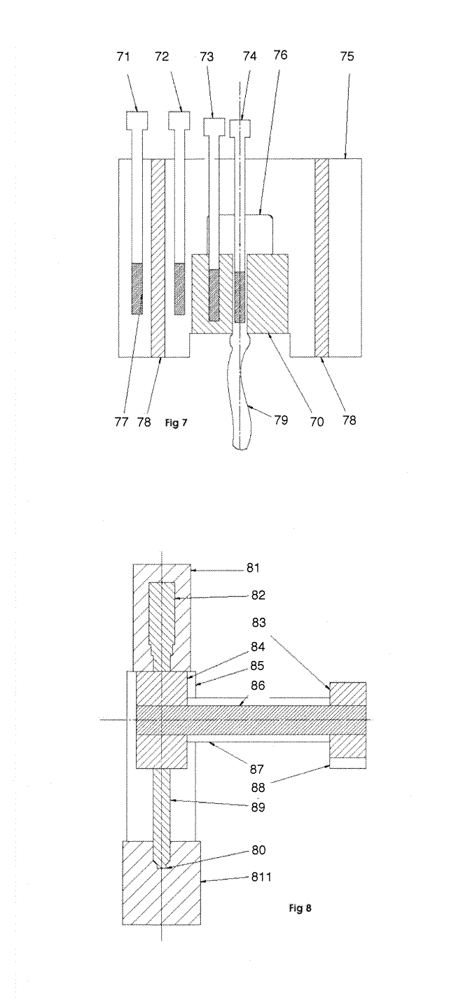

More specifically, one aspect of the invention features a die with certain characteristics and profile, as reflected in FIG. 6A, being a sectional view of a 2 mm diameter MFI die; that is die 65 in situ with a die block 62, equipped with the pressure transducer 63; molten polymer is metered into a die entry chamber 61, through a 6 mm diameter passage way 69, which in turn connects to a metering device, for example a piston or gear pump.

The die entry chamber is component B of so-called cluster die regions referenced later; this chamber is of 15 mm diameter at the centre line of a delivery passageway; the die entry starts with a taper section, which is component C of the cluster die regions; it has a slope angle of approximately 9.5 degrees; another taper section, region D connects to a true die capillary, region F; a compensation region, component E is omitted, as not being necessary in this particular configuration; regions D and F are connected through 3 mm radius corner 67, which is tangential to an 80 degree, wide-angle taper 68, terminating with a sharp edge to the 2 mm capillary; again, a so-called compensation region G, at the capillary exit is omitted as it is not necessary in this design; the start of the radius is at a diameter 10.21 mm; the die is threaded into the die body; the die material is nitrided steel; the capillary is ground to length after the bore has been honed to size; the bore is sized to better than +/−2 microns and the length is sized to better than +/−5 microns; molten polymer issues from the capillary, swelling at the sharp edge of the capillary exit, region H and draws down to a tail I, H and I, as shown in FIG. 7; the die body is heated with cartridge elements disposed in a symmetrical pattern with respect to the die axis and a transducer.

Another construction arrangement features a complementary set or group, and in particular a pair of dies, respectively an MFI die and a Rheology counterpart, such as depicted in FIG. 6B, fed from two separate streams; which can be generated, say, a two-stack gear pump, that is one having one inlet and two sets of metering gears, and/or a spool valve.

A further construction arrangement makes selective use of certain elements of existing polymer process or process control, rheometers, in particular a gear pump for polymer melt throughput drive, to achieve and alternative improved measurement following the agenda of the present invention; whilst allowing those elements to retain their original purpose. In that sense the Applicants have configured a rheometer of improved characteristics or have perceived and purposefully harnessed the subliminal and hitherto unrecognised and unused opportunity latent within existing structures.

A gear pump, with input and output polymer melt flow paths to an intermeshed gear assembly in a chamber within a common housing block, with input and output pressure transducers at respective opposite side of the gear assembly, with temperature transducer probe into the chamber, is adapted for rheometry by adaptation or (re-)use of the gear chamber effectively as a pressure and temperature conditioned restrictor die of stable constructional dimensions and operational character for an established conditioned polymer melt throughput. The gear chamber housing block conveniently features a SCADA communication interface for remote monitoring and relay of sensory data. Embodiments

There now follows a description of some particular embodiments of the invention, by way of example only, with reference to the following simplified diagrammatic and schematic drawings, in which:

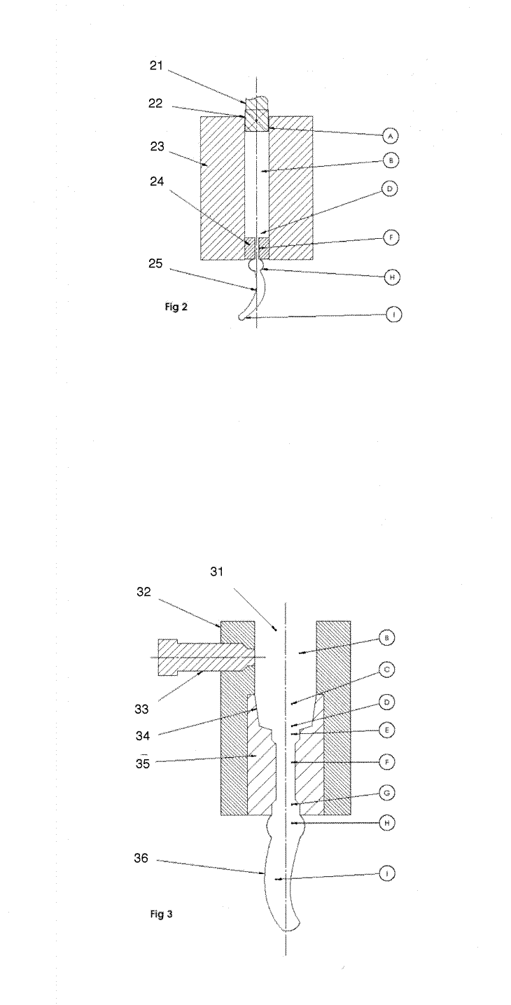

FIG. 1 is a table of die categorisation, by part and flow region; with respective references having counterparts in FIGS. 2 through 6B;

FIG. 2 is a cross-section of a standard MFI test chamber, with prescribed piston displacement, chamber, measurement die entry and chamber exit;

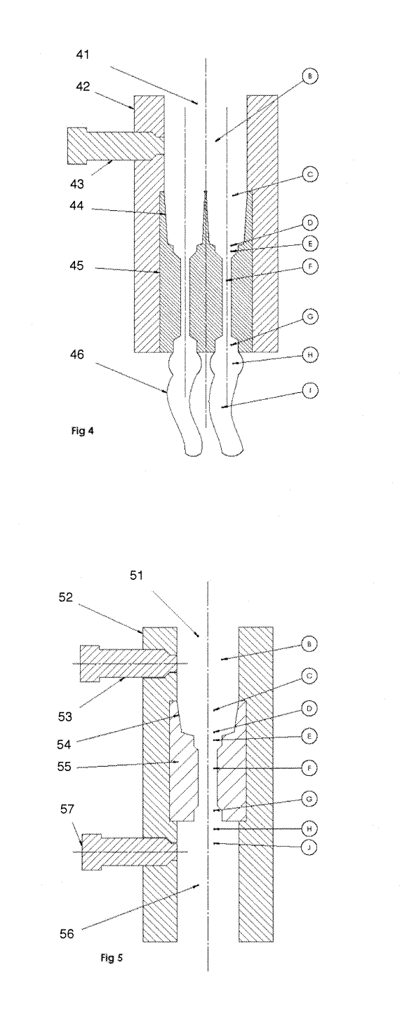

FIG. 3 is a cross-section of a single die MFI test chamber with complementary die entry and exit profiles of the invention, in a non return-to-stream configuration;

FIG. 4 is a cross-section of a dual orifice die MFI test chamber and die variant of FIG. 3, again in non return-to-stream configuration;

FIG. 5 is a cross-section of a single orifice die in a return-to-stream test chamber configuration;

FIG. 6A is a cross-sectional of a bespoke profiled MFI test chamber and complementary die of the invention;

FIG. 6B shows a rheological counterpart die to FIG. 6;

FIG. 7 shows a sectional view of multiple thermometer die block;

FIG. 8 shows temperature-controlled zones for a die block using a lateral or transverse supported heat pipe

FIG. 9 shows temperature-controlled zones for a die block with multiple, self-supporting longitudinal heat blocks;

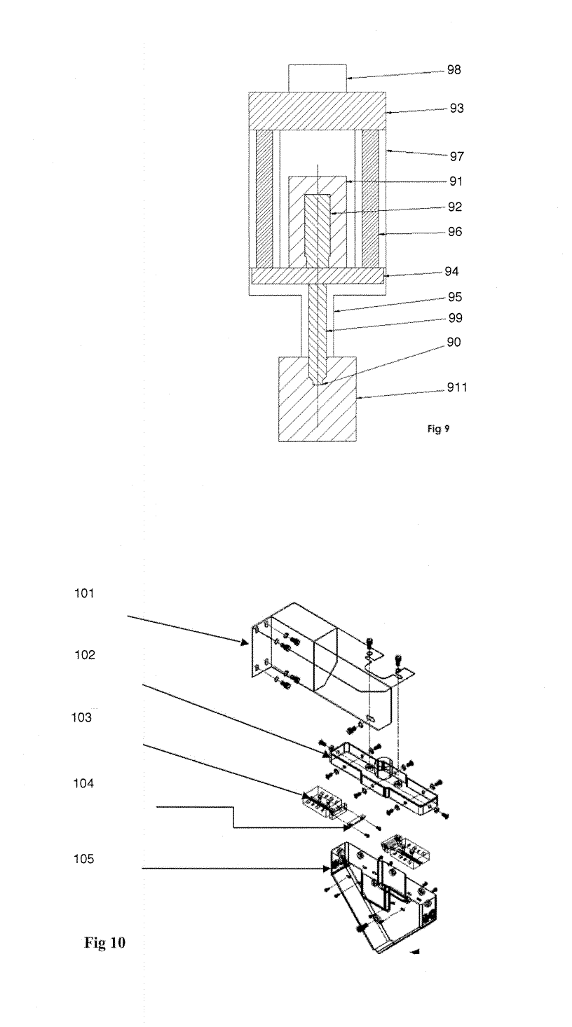

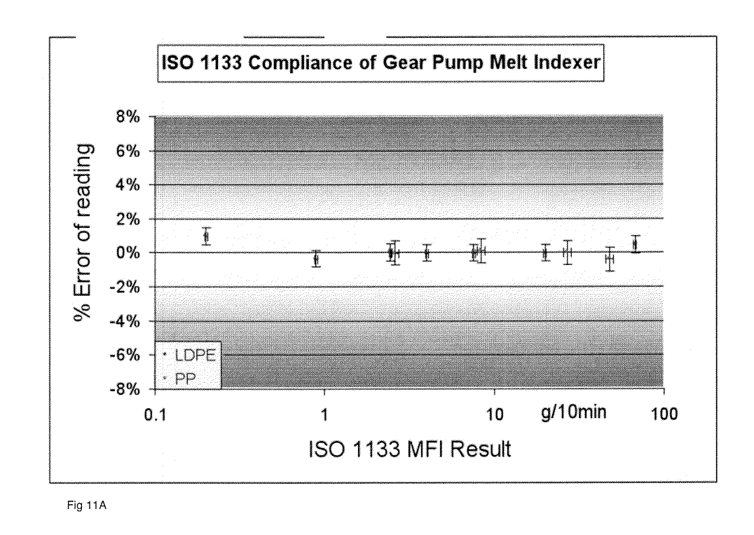

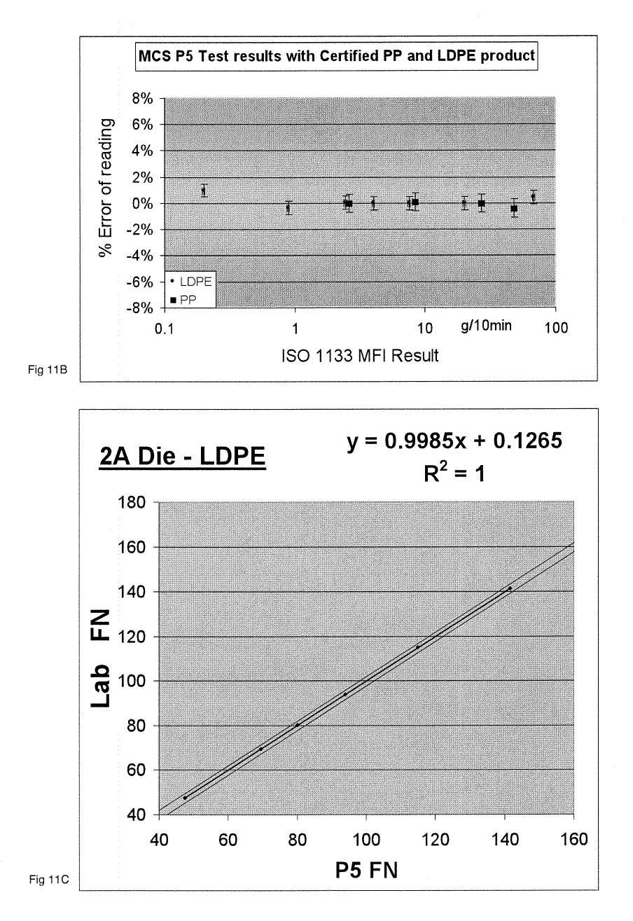

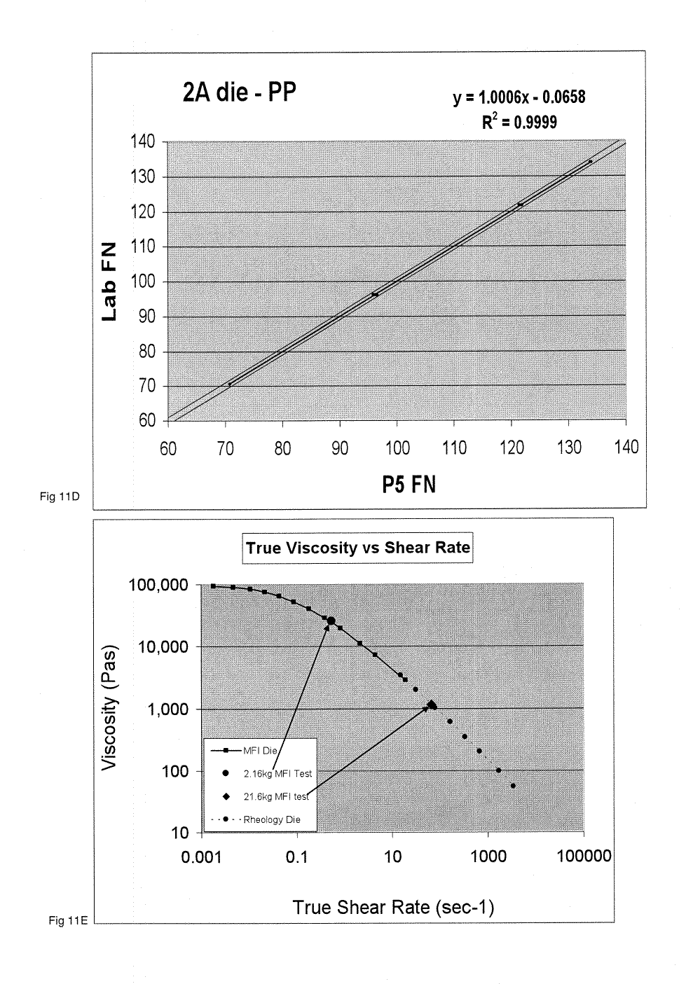

FIG. 10 shows an exploded ghosted outline 3D view of an automatic extrudate cutter, configured to sever extrudate close to a die exit;

FIGS. 11A through 11E show a series of graphical plots, with respective summary headings, reflecting a degree of MFI conformance or compliance for a range of two polymer types namely polypropylene (PP) and low density polyethylene (LDPE), with ‘before and after’ comparisons upon implementation of the invention, as compared to conventional measures; improvements include a calibration graph with an error band of +/−3%; an error graph for LDPE/PP and a 2 mm die; rheology plot for 1 and 8 mm dies;

FIGS. 12A shows an overall compact assembly and FIGS. 12B through 12D show local component or sub-assembly sections; with combined pressuriser, measurement head heater, conditioner, temperature sensor and gear pump; essentially, the drive head of FIG. 12B acts as an intensifier forcing solid polymer into a measurement head, where it is melted; the pressure exerted on the polymer is controlled by the air pressure on the larger piston 121; paired dies 122 are shown in FIGS. 12C and 12D, such as an MFI die and a rheometer die; a thermal jacket 123 is placed around the two silicon-on-sapphire pressure transducers to minimise thermal effects on temperature compensation resistors, this to substitute for heat pipe stabilisation equipment; three temperature sensors 124 are used, of which two are used to detect liquid polymer temperature in the die capillary from established relationships found experimentally with probe in the capillary (then removed) and the third is used for die temperature control; a diverter valve 125 in the die block is used to direct polymer to either of two dies; an input shaft 127 is presented for gear pump drive;

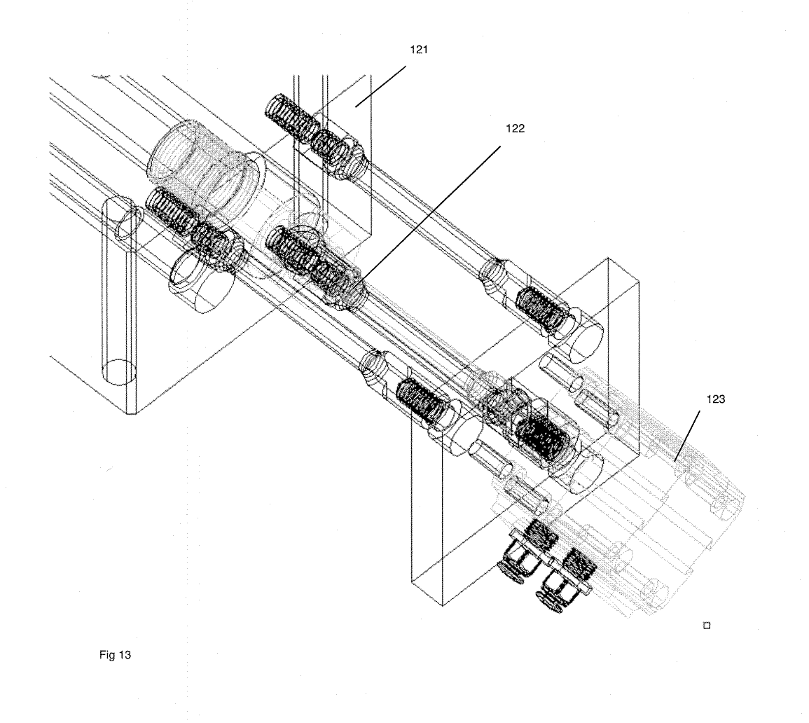

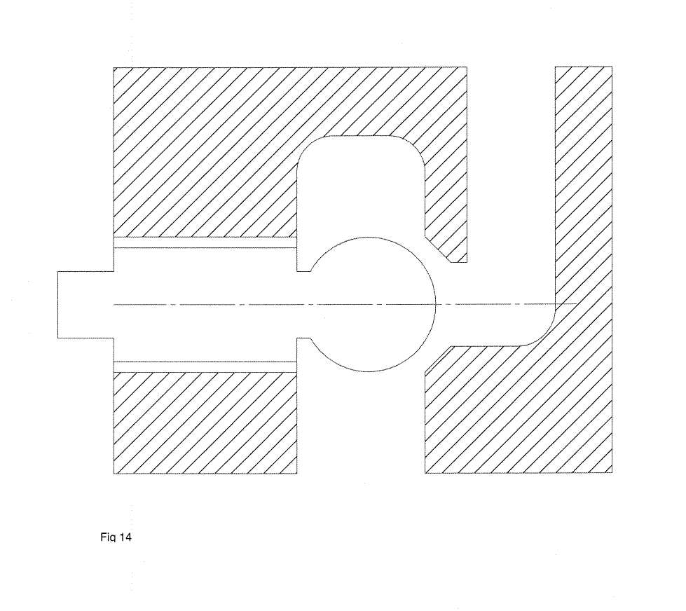

FIG. 13 shows an exploded, ghosted outline 3D perspective view of a multiple die block, in a return-to-stream configuration;

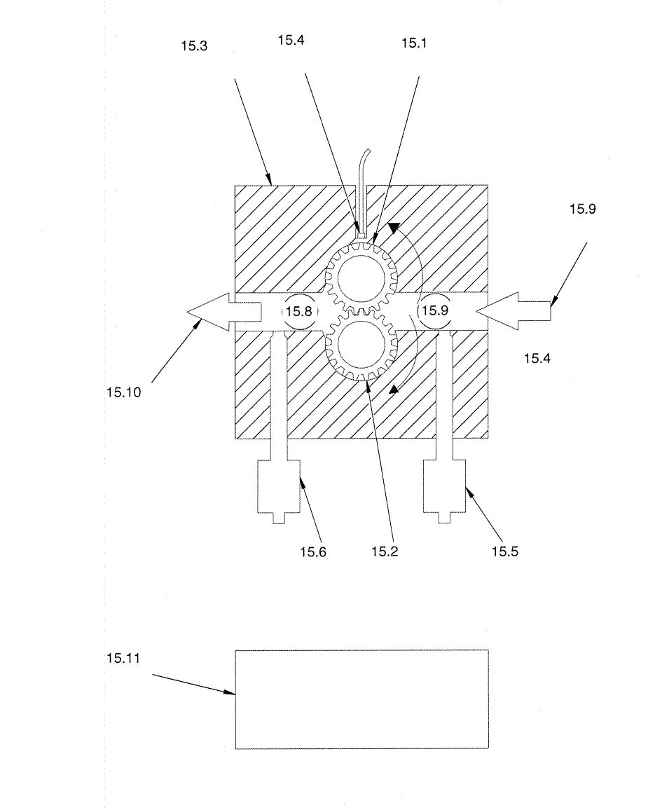

FIG. 14 shows a local sectional detail of a variant return-to-stream die block configuration, with a revised pressure control scheme, featuring a flow director valve with a ball head mounted upon a shaft with a screw thread (of differential or non-differential drive pitch) to rotate the screw and ball into and out of closure contact with a seating face, to direct the flow stream; a pressure sensor located at a metering gear pump inlet is used to control pressure at the gear pump inlet through position of the ball with respect to a seating face to say 25 bar when the flow rate is less than, say, 0.3 gm/minute; at flow rates above 0.3 gm/minute the ball is moved off the seat to achieve the full line pressure. Intermediate conditions can also be achieved at any set pressure and flow conditions;

FIGS. 15A and 15B show an adaptation or (re-)use of certain elements of an existing gear pump such as in a polymer plant polymer melt throughput flow drive, to achieve a rheometer, rheometer configuration or certain rheometric functions. Inherent internal flow path restriction is utilised to serve as a die. Such a die could be one in a die grouping or cluster for a cluster, replicate or emulated measurement standard as in the prefacing discussion of the invention.

A gear pump restrictor or die equivalent could be a stand-alone element. That said, conceivably (although not shown) multiple gear pump internal sets, each with its own particular restriction or die characteristics could share a common housing block. In that way parallel measurement streams might be contrived for comparative or cross-referenced measurements. A given polymer throughput flow could be shared between dies or switched or diverted to an active die, allowing for settling down of otherwise potentially disturbing entrance and exit effects.

Referring to the drawings, in the component part reference scheme, corresponding parts in different Figures are accorded the same reference ‘unitary index’ numeral with a preceding ‘decimal or tens’ index reflecting the Figure number. Thus, for example, components 38 and 58 reflect a common part (8) in FIGS. 3 and 5 respectively. FIGS. 15A and 15B have an independent reference number sequence.

Melt Flow Index Measurement

Key features of MFI apparatus are shown in FIG. 2, for use in a wide variety of configurations, according to polymer fluidity. Test weights can vary from some 0.3 kg to 21.6 kg. The die entry is routinely some 9.525 mm diameter. Die dimensions are usually 2.095 mm diameter and 8 mm length, with a ‘half size’ die as an alternative for polymers with a high fluidity. MFI is useful as a low-to-very low shear rate measurement. The lowest and highest flow rates achievable are of the order of 20 milligrams per minute and 20 grammes per minute, respectively. In a 2.095 mm die, the corresponding shear rates are 0.5 and 500 sec⁻¹. At the highest flow rates, piston apparatus is limited by rapid fall-off effective piston pressure. At the lowest flow rates, piston apparatus runs into difficulties of seepage and polymer change, due to long residence time. Anti-oxidant or stabiliser additions ameliorate, but by no means obviate, the polymer material changes. Many MFI test equipment types use LVDT displacement measurement and/or friction-free piston guidance systems to overcome some of such basic deficiencies.

Well-designed equipment can now achieve a mid-range so-called 3-Sigma standard reproducibility of the order of +/−2%. This reflects that operator and random errors can be contained through best practice, as defined in the most recent version of ASTMS D1238 MFI.

This recent improvement significantly clarifies MFI test analysis, but before replacement by more productive automated MFI measurement equipment can be contemplated, remaining systematic errors need to be fully understood and allowed for.

Many such systematic errors of standard MFI apparatus are caused by time-dependent pressure variations, which are inherent properties of a piston rheometer. There are four main causes of such pressure variation:
1. Seepage of polymer into a clearance gap between piston and bore produces a varying force on the piston, thus progressively changing the effective pressure at the piston tip during the period of measurement.
2. Pressure drop between piston tip and die, as extrusion proceeds, is dependent upon the column length of molten polymer remaining.
3. At or beyond the die exit, the extrudate swells. This represents a (small) pressure recovery, which is dependent on polymer properties.
4. The polymer tail exerts a small ‘down-pull’ on the extrusion. This draw-down force increases the flow rate and is time-dependent according to the weight extruded. The tail is usually clear of any floor stop below the die.

It also takes time for a flow pattern to establish and settle. This can be due to elasticity effects and any eddy formation. Certain polymers can flow erratically. It is recognised that these 55 conditions give rise to a time-dependent flow rate. The actual developed piston pressure is not defined by the standard, so is estimated by measurement and/or calculation, to derive a most representative (optimum) pressure condition for each polymer. A common practice is to state a measured flow rate when the piston tip is at an ‘end of test’ marker, some 25.4 mm above the die entry as conditions most representative of an MFI test.

Replicate Melt Flow Index and Accompanying Rheology Dies.

Computerised/Computational Fluid Dynamics (CFD) Determination.

One aspect of the invention uses CFD, better to understand polymer fluid flow in die systems. CFD has been used throughout the MFI apparatus and many trial die systems in relation to pressure drop. This embraces flow from the piston into an important die entry region, through the die and on to the die² exit. For so-called ‘replicate’ apparatus, flow from a die inlet pressure transducer point is considered.

In both cases this pressure drop is offset by a small pressure recovery or pressure loss at the die exit; but this can be ignored if the replicate apparatus is operated strictly in the same way as the MFI apparatus. The total pressure drop calculated must be reconciled with the effective pressure generated by the piston in the MFI equipment³. Flow and pressure drop in the ‘true’ capillary region can accurately be described using conventional non-Newtonian shear viscosity relationships. However, flow and pressure drop in the die entry and exit regions are extremely complex, due to the interaction of shear and extensional flows⁴.

In Applicant investigations, referenced in Appendix 2, understanding the flow in the die was broken down into an iterative procedure, over a trial test cycle. Two test cycles, were found necessary to achieve a satisfactory design, with simple dies designated series ‘A’; more complex dies required upwards of three test cycles. A test cycle is generally as follows: —
Characterise rheological properties of a standard polymer samples over a shear rate range two decades to either side of the MFI flow rate. Use pairs of Long and Short dies⁵. Match test temperature of MFI test.
Simulate flows in MFI apparatus geometry with CFD, using a Power Law model for shear viscosity generated from stage 1⁶.
Repeat foregoing stage 2, using CFD with a series of die formulations⁶.
Adjust stage 2 results, using CFD with selected extensional viscosity models in die formulations as per preceding stage 3⁷.
Check MFI compliance of selected die formulations with standard polymer samples.
Repeat 1-5 as necessary with new dies designed from experience gained.

In CFD investigation of entry flow, it was found possible accurately to calculate the dynamic relationship between dies of differing diameters. This enables a rheometer configuration of two or more dies that can seamlessly measure shear viscosity and MFI over a very wide shear rate. At least one die must be an MFI replicate. Extensional viscosity can be measured over a substantial range. Using this die system all measurements can be referenced to an MFI standard. CFD thus becomes part of the standardisation process.

Note Annotations

¹ A cylindrical orifice refers to a capillary. ‘Die’ refers to a solid object with an orifice, through which fluid under test passes.

² The extrudate tail is trimmed on occasions to prevent excessive pull down forces being generated.

³ The effective pressure generated by the MFI equipment piston is estimated by CFD and by empirical fits with test results, but not measured in the Melt Indexer.

⁴Shear and extensional viscosity parameters are related to the die geometry from which they are derived. Shear viscosity of a polymer is usually represented by a power law of shear rate.

At low shear rates viscosity can be represented by a plateau. Extensional viscosity is described by a model. There are four well known models: Cogswell, Gibson, Binding and Rides.

⁵ Long and Short dies have identical inlet geometry and capillary diameters, but differing lengths. This follows conventional rheology practice. Shear viscosity is calculated from the true capillary and extensional viscosity from the die entry, by assuming identical entry pressure drop in both dies at any given flow rate.

⁶ An objective is to achieve parity of pressure drops in all die regions, as described later in relation to a so-called ‘Cluster Die’. Conventionally, a twin bore would also calculate shear viscosity from the true capillary and extensional viscosity from the die entry, by assuming identical entry pressure in both dies at any given flow rate.

⁷ The Cogswell model was abandoned as too simplistic in formulation. The Gibson model was used in the first two cycles, particularly for the calculation of shear and extensional viscosity pressure drop in the die entry region. This resulted in a die series designated ‘A’. Binding and Rides models were used in more refined calculations, towards a die series designated ‘B’ (not shown).

Replicate/Cluster Die

A particular version or expression of a so-called ‘replicate die’ aspect of the present invention is termed a ‘Cluster Die’, as a means to replicate a target rheological test, such as, but not limited to, a Melt Flow Index test. A Cluster Die features a delivery chamber region and an exit chamber region, which are necessary to define any rheological test employing a die. A cluster die may have one or more orifices; hence the designation ‘cluster’. These orifices may be in a shared body or housing or respective individual bodies.

A Cluster Die may be connected to a positive displacement device, such as single gear pump or piston in bore, as in a twin bore rheometer. One aspect of the invention uses elements of an existing gear pump for this purpose, whilst those elements retain their original purpose, A die orifice internal and bounding, communication or access profiles may have a significant ‘interactive’ effect upon measurement conducted using the die. Any capillary diameter, entry chamber diameter or exit chamber diameter may be employed. All orifices share, and therefore have interactive entrance/exit effects with, the delivery/exit chamber regions. A cluster die can use so-called ‘Compensation’; by adjustment of dimensions of an individual or a collection of regions to enable mimic or emulation of the total characteristic of a standard test die. Such Compensation can use any number of regions, as needed, and can take the form of a non-circular cross-section or taper in any of the regions.

Two Classes of Cluster Die of the invention are defined as:

Normal Die

A so-called ‘normal die’ exhibits a nominal pressure drop equivalent to that of a so-called ‘standard die’ which it replicates. An example single orifice MFI die is shown in FIG. 3. A dual orifice MFI die is shown in FIG. 4 and is rheologically equivalent to two dies operating in parallel. In this special case, the purpose of the multi-orifice die is to achieve accurate MFI measurement of very high molecular weight polymers, such as high density polyethylene (HDPE) at low test weight conditions. The shape and orientation of transition regions between die entry chamber and die entries are adjusted to ensure equal or near equal flow rates through each individual capillary section.

Rheology Die

A so-called ‘rheology die’ accompanies a normal die of MFI type to make a rheology set or ‘suite’ of dies. More than one rheology die can be used and any rheology die can be a MFI die. A suite of dies employs differing capillary diameters. This innovation departs from conventional practice⁵. It has been observed from extensive CFD studies and tests that the entry pressure drop can be nearly independent of the capillary diameter. For example, when the dies have entry shapes as shown in FIGS. 6A and 6B, the entry pressure drops differ by a few percent. This small difference can be compensated by CFD calculation, using a database of shear and extensional viscosity data appropriate for the polymer under test. Alternatively, the entry shape of the rheology die can be adjusted for better match of entry pressure with the MFI die, using CFD and testing to achieve the desired result.

The rheology (measurement elements, such as dies) ‘suite’ of the invention has uniquely ensured that all rheological characteristics are accurately referenced to an MFI standard. The die suite also has the capability to derive accurate Shear Viscosity, as a function of shear rate, etc, over a very wide range. This gives ready access to polymer structure ‘assays’, such as Molecular Weight Distribution (MWD). MWD is measured from curvature or shape of a shear viscosity/shear rate plot. For polymerisation control purposes, it very useful to measure down to shear rates of 10⁻³ sec⁻¹ and below. The measurement of shear and extensional viscosity at medium to high shear rates etc is important in the simulation of polymer applications, such as moulding and extrusion.

MFI Die System Classification

For the purposes of analysis, standard MFI and replicate MFI die systems are each broken down into discrete flow regions. Six flow regions of the MFI apparatus are identified by letters of the alphabet in the table of FIG. 1 and in FIG. 2. FIG. 1 shows flow regions for examples of replicate MFI die systems. For the MFI case, six regions are identified in FIG. 2. The component parts are identified as follows:

A piston 21 is equipped with a tip 22, which fits into an electrically heated bored barrel 23. The piston tip 22 has a close, running-fit in the bore of barrel 23, to drive molten polymer samples through a die 24. The piston 21 is equipped with, or loaded by, a weight, not shown, to provide a small driving force to the molten polymer. One aspect of the invention is on a ‘normal’ type of capillary die, 2.095 mm diameter by 8 mm long. The die has a 180°, ‘flat’, entry and exit. The bore of the barrel is 9.525 mm and the distance from the piston tip to the die entry at the final limit of travel is approximately 25.4 mm. Extrudate 25 exiting the die first of all swells and then draws down into a tail by self-weight. FIG. 2 shows the extrudate tail 25 after a given period of extrusion of molten polymer from the MFI equipment. The definition of MFI measurement can be expressed as the flow rate of material extruded through the die expressed as g/10 mins, or in cc/100 mins, converted by a measured or assumed density. The latter is termed Melt Volume Rate and can be referred to as MVR.

The flow regions of the die for various automatic rheometer configurations are depicted and referenced in FIGS. 3 through 5. A common numerical identification of component parts is used in these three diagrams, with the exception of an additional part in FIG. 5.

FIG. 3 depicts a cross-section of a polymer measurement head in the single orifice, non-return-to-stream configuration. The measurement head is housed in a die block 32. A gear pump (not shown) delivers molten polymer to a die inlet region 31 of the head. A die 35 is housed in the die block. In this form of apparatus, the gear pump is constrained to deliver molten polymer at a known melt flow rate, which assumes a known melt density of the polymer and a known volumetric delivery of the pump. A pressure transducer 33 is situated at a 25 mm nominal distance from the die capillary entry, as in standard MFI apparatus at the final limit of travel. Molten polymer passes through the die orifice, and free falls to atmospheric pressure, thus forming a tail of extrudate 36 in a similar manner to standard MFI apparatus. The pressure transducer 33 may be positioned with its diaphragm in any orientation with respect to the capillary entry. Transducer 33 measures pressure drop across the whole of the die tract, relative to atmospheric pressure, in order to emulate conditions of a standard MFI test. The die block 32 is electrically heated, to maintain polymer at any of the standard melt temperatures, as employed in the MFI test. The die 35 is normally retained in the die block 32 by a screw thread on the outside diameter of the die. A male hexagonal key (not shown), formed at the die exit, is normally used to mount or detach the die. The die 35 and the transducer 33 are mated to the die block 32 in a leak-free fashion, so that all polymer delivered from the gear pump passes through the die.

FIG. 4 depicts a cross-section of a polymer measurement head in a dual orifice, non-return-to-stream configuration. This apparatus differs from the single orifice configuration of FIG. 3 only in die formulation. Corresponding parts in FIGS. 3 an 4 have similar indexed references.

FIG. 5 is a cross-section of a single orifice, return-to-stream configuration. A second (downstream) pressure transducer 57 is employed to establish the differential pressure drop across the die. The flow from the die exit is normally constrained by the action of a scavenger gear pump (not shown), which can result in pressure conditions at the die exit being maintained at some 1-3 bar above atmospheric pressure. Nevertheless, the die exit is maintained in a flooded condition, where the exit surfaces of the die are completely covered with polymer. Polymer in the die exit chamber 56 corresponds to the extrudate tail 25, 36, 46 respectively of FIGS. 2, 3 and 4. The single die shown can be replaced with a multiple orifice die, as required. Again, die mounting detail is not shown.

For good scavenging and ease of manufacture, radii, and wide angle tapers can be used as transitions between regions. But a sharp or abrupt edge is required at the entry and exit of the true capillary. The working surfaces of the die must be hard to inhibit wear and to achieve a stable calibration status.

| | Category | | | |
|---|---|---|---|---|
| | | Single orifice | Dual orifice | Single orifice |
| | Std | non-return | non-return | return |
| | MFI | to stream | to stream | to stream |
| | Drawing | | | |
| Die region | FIG. 2 | FIG. 3 | FIG. 4 | FIG. 5 |
| Seepage | A | — | — | — |
| Delivery | B | B | B | B |
| chamber | | | | |
| Taper | — | C | C | C |
| Die entry | D | D | D | D |
| Convergent | — | E | E | E |
| compensation | | | | |
| True capillary | F | F | F | F |
| Divergent | — | G | G | G |
| compensation | | | | |
| Die exit | H | H | H | H |
| Extrudate draw | I | I | I | — |
| down | | | | |
| Exit chamber | — | — | — | J |

Examples of a Replicate MFI Die and its Rheology Counterpart

A main focus of the invention is the replication of die entry diameter (9.525 mm) and the placement of the entry region of the capillary at a distance of 25.4 mm from the inlet pressure transducer. These dimensions correspond to two principal dimensions of standard MFI apparatus.

To a first order of approximation, a so-called Gibson model predicts that that the extensional viscosity component of pressure drop is correct at a 90° entry angle. However, the die is better optimised with an entry angle of 85°, which reflects that other influences, including the radius at entry and piston pressure drop compensation, are perturbing the Gibson result.

Pressure drops calculated by a CFD modelling process are an indicator in support of proof of concept.

FIG. 6A shows a simple, ‘successful’, die 65 in a MFI measuring head. A pressure transducer 63 is mounted axially above a die entry. Polymer from the gear pump (not shown) is admitted into a 15 mm diameter die entry chamber through a side passage 69. A slow or gradual taper 64 of approximately 9.25°, followed by a 3 mm radius edge transition 67 and an 85° entry angle 68, channels the polymer towards a capillary proper. At the end of the taper the chamber is 10.21 mm diameter. The die is externally threaded and keyed with an external hexagon form 60. This single orifice MFI die has a 2.0 mm diameter capillary section that is 7.636 mm long.

A rheology die counterpart to the MFI die of FIG. 6A is shown in FIG. 6B. In this instance the rheology die is an MFI die format having a capillary length of 14.535 mm and a diameter of 3.5 mm. This rheology die gives access to low shear rheology. An alternative would be to use a small capillary diameter to gain access to high shear rate rheology. More than two dies may be used.

FIG. 11B shows graphically the degree of MFI conformity for a range of two types of polymer. The samples of Low Density Polyethylene (LDPE) polymer were between 0.2 to 190 MFI and Polypropylene (PP) Polymers were between 2.60 to 47.81 MFI.

Melt Pressure Transducer Stabilisation

Most melt pressure transducers are very sensitive to ambient temperature fluctuations, which militates against precision rheology.

A liquid-filled type melt transducer employs a capillary to transmit the melt diaphragm pressure to a second chamber, on which a strain gauge is placed. These devices are prone to temperature fluctuations anywhere in a liquid-filled system. They also exhibit susceptibility to any relative height movement of a melt diaphragm and strain gauge.

The silicon-on-sapphire and silicon-on-insulator types of melt pressure transducer fair better than the liquid-filled devices, due to the close coupling of the strain gauge element and the fluid under test. These devices can still exhibit a slow zero drift, due to the minute settlement of any part of the silicon strain gauge and/or its supporting structure. These devices can also exhibit temperature dependent fluctuations if any temperature compensation devices are placed outside the influence of the temperature controlled zone of the diaphragm.

The stability of the liquid-filled melt transducer can be improved by control of the thermal environment of the entire pressure system and its compensation parts. One aspect of the invention is a means of maintaining a known thermal environment around the diaphragm, the capillary and the strain gauge chamber in the liquid filled case. This is achieved by the use of three temperature-controlled zones. These zones are isolated from ambient by insulating blanket materials. Two versions are illustrated in FIGS. 8 and 9. The component references for these Figures are as follows:
81/91 heated enclosure for a gauge section of pressure transducer, controlled at 60-70° C.
82/92 gauge section of rigid stem pressure transducer
83/93 temperature-controlled heat sink running at 30-40° C.
84/94 conduction block joining pressure transducer stem to heat pipe
85/95 ceramic foam or similar insulator for pressure transducer stem
86/96 heat pipe
87/97 ceramic foam or similar insulator for centre section of heat pipe
88/98 optional fan
89/99 rigid stem section of pressure transducer
80/90 diaphragm sensing polymer melt pressure relative to atmosphere
811/temperature-controlled die block, operating at test temperature,
911 typically between 190-310° C.

Pressure transducer stabilisation is achieved by creating two rigidly-controlled temperature zones, at a sensing diaphragm 80, 90 and a gauge 82, 92. The purpose of a (longitudinal or lateral) heat pipe 86, 96, is to divert heat flux from a die block 811, 911, which would otherwise overcome the gauge temperature control zone regulation. Excess heat flux is dissipated in an offset or outboard heat sink 83, 93. At high ambient temperatures an optional fan 88/98 becomes necessary. Insulators 87, 97 and 89, 99, reduce perturbation of the ambient temperature variation. It is important to preserve the integrity of the insulation layers. Any small gaps at the extremities of the insulation will cause deterioration in performance.

In FIG. 8 a lateral heat pipe projection 86 requires mechanical support. In FIG. 9 multiple, typically three, longitudinal heat pipes 96, bridging a heat sink 93 and conduction block 94 at opposite ends, are sufficient to provide adequate mechanical support. When the control zones are well tuned, temperature fluctuations can be better than +/−0.1° C. With a good quality ceramic foam insulation, wrapped in aluminium foil, a rigid stem transducer has shown fluctuations of zero output better than +/−0.007% full scale, when subjected to ambient conditions between 30° C. and 12° C. The transducers show full scale calibration stability better than +/−0.1%. These effects have been observed on two good quality transducers, Asentec SF/1000/1/2/318/50 and Dynisco PT420A-5C-12, both of which are suitable for use in liquid polymer measurement duties. In contrast, examples of the Sensonetics silicon on sapphire type 401-M-10-6-C2 when the stem is wrapped with a good quality glass work and an enclosing stainless steel foil, have shown fluctuations of zero output of +/−0.0005% full scale over a period of 5 weeks.

Gear Pump Melt Delivery Improvement

Some polymer metering gear pumps (not shown) require only some 25 bar inlet pressure to maintain perfect volumetric efficiency, but at the highest flow rates the charging pressure has to be considerably higher, typically in the range of 100-250 bar. Another aspect of the invention is regulation of polymer pressure at a gear pump entry, at a level related to the speed of a pump drive motor. An embodiment of this invention (not shown) has been devised, which feeds a ram intensifier with compressed air from either of two air lines. Air line pressures are set respectively at 5 bar and a 0.5 bar. At a flow rate at or above 0.3 g/min the bar line is used; below 0.3 g/min the 0.5 bar air line is used. A ram intensifier is used to feed a gear pump via a static melter. Motor torque effects or drive pressure loading at stable rotational speeds and through flow under different pressure and temperature conditions may be a factor in this and the embodiment discussed later in relation to adaptation of existing 60 gear pump and polymer process plant or apparatus.

A realistic target for MFI measurement is to encompass a range form 0.007 to 200 MFI_{2.16 kg}. For rheometer measurement is desirable to cover shear rates of a range greater than 0.001 sec⁻¹ to 50,000 sec⁻¹. Both targets can be achieved by using a gear pump working in a range of approximately 30,000:1. Available advanced stepping motor technology provides the required speed range. The lowest controllable flow rate achievable was less than 1 milligram per minute.

Molten Polymer Temperature Measurement

In any polymer melt test involving a die it is useful to know the polymer melt temperature, throughout the die region of the rheometer, at all stages of the test, along with the die temperature and that of the surrounding metal. Continuous monitoring of temperature in a flowing stream of molten polymer can be achieved by a fully-immersed temperature probe. An ideal probe would be passive, having no thermal mass or conductive connection to the surrounding mass. A practical alternative is achievable with a calibrated platinum resistance thermometer (PT100), encased in a thin stainless steel sheath of 3 mm outside diameter. If the probe is thermally supported by a surround that is part of the temperature zone controlling the liquid temperature, it is possible to reduce the measurement error to better than +/−0.1° C. by using calibrated thermometers. The probe typically has a sensing length of 20 mm, which means that the measured temperature is related to the average temperature over that 20 mm distance. The rheological tests of interest are defined around a capillary die of circular cross-section, which precludes the use of a temperature probe in the die tract itself during the test, as this would make the geometry of annular form.

An aspect of the invention relates to placement of a reference thermometer in structure surrounding the die tract, to act as a temperature measurement of the liquid passing through the die. The system is initially configured, as reflected in FIG. 7, to establish the dynamic temperature relationships of various temperature probes. The component parts of FIG. 7 are as follows:
71 PT100 temperature probe
72 PT100 temperature probe
73 PT100 temperature probe
74 PT100 temperature probe
75 electrically heated die block
76 die chamber
77 hatched area showing extent of PT100 sense element
78 cartridge heater
79 polymer extrudate at exit of die
70 temporary die

In a final configuration, for routine use in automated tests, die block 75 is equipped with a pressure transducer in place of probe 74. Probes 71 and 72 remain, but probe 73 is eliminated.

Probes 71-74 occupy positions on a radial plane of the die block 75 shown in sectional view. The die block 75 is electrically heated by cartridge heaters 78 or band heaters (not shown) to provide a near uniform temperature zone. Probe 71 is used for control of the block to the specified test temperature. Probe 72 acts as a permanent molten polymer temperature probe. Die block 75 and die 70 are specially modified for a calibration exercise. System calibration is achieved by using test thermometer probes 73 and 74. Probe 73 is placed in a blind hole in the die 70, through an entry hole in die block 75 proper. Probe 74 enters die 70 at the position normally taken by a pressure transducer. This probe can be re-positioned in order to measure temperature at various positions along the axis of the die. By monitoring the above four temperatures under varying conditions of melt feed and die temperature, it is possible to establish relationships between probe 72 and probes 73 and 74.

Movement of probe 74 along the die axis is particularly useful in establishing conditions that provide molten polymer at the chosen test temperatures. The probe can be placed clear of the top of the die or at the die centre; thus distinguishing between polymer conditioning prior to the die block and conditioning by contact with the die or its surrounds. Probe 72 acts as a means to analyse the temperature gradients, especially with probe placements that follow the radial plane. The calibration procedure established that the passageway between the gear pump and the die block was colder than the test temperature and therefore required an additional heating zone. In the final configuration, probe 72 can be used as a watchdog or sentry, on whether or not the optimal settings found are being continually applied.

Extrudate Cutter

Due to the extended duration of any test, an ‘At-line’ rheometer is capable of producing a heavy extrudate, which will reduce the perceived pressure measured across the die. An automatic extrudate cutter, such as of FIG. 10, has been used to chop or sever the extrudate close to the die exit. The component parts in FIG. 10 are as follows:
101 optional attachment frame
102 extrudate feed tube and top cover
103 rapid acting air cylinder with guided piston rod (one of two)
104 cutter (one of two)
105 safety cage with extrude slot at lower extremity Two cutters 104 are close together, with their edges almost touching, thus severing the extrudate stream(s). Cutting blade travel is 25 mm; sufficient to allow good clearance of the extrudate as it is formed. The cutter blades 104 are of hardened steel. The blades 104 are of a sufficient thermal mass to prevent adhesion of the semi-molten polymer, when operated at approximately 20 cuts/minute. The extrude drops through a slot in the bottom of the safety cover 105. The slot is dimensioned and positioned to prevent inadvertent entry of the human hand. As a safety shut-down and run interlock, the equipment is fitted with an intrusion sensor (not shown), which also acts as a blockage detector. The overall configuration is with safety provision in mind, to inhibit inadvertent foreign body, such as operator digit, intrusion.

Pressure Relief Valve

A return-to-stream Melt Indexer/rheometer operational duty includes pumping polymer back into the extruder, which can run well in excess of the maximum pressure limit of the pressure measuring devices used in the system. An aspect of the invention, reflected in FIG. 12, is a relief valve that actuates below the pressure transducer(s) service limit, enabling risk-free deployment of pressure transducers with a low pressure span. The device doubles up a means of de-pressurising the device for the purposes of establishing an accurate zero ambient pressure point, which is an essential part of the system calibration. The component parts of FIG. 12 are as follows:
121 return-to-stream Rheometer/Melt Indexer body
122 push rod with ball end
123 air cylinder actuator

A Rheometer/Melt Indexer uses a return-to-stream gear pump (not shown) to deliver polymer back to an extruder, acting as a scavenge pump. It normally runs at 1-3 bar above ambient. A body 121 has a gallery connecting the exit of the die(s) to the entry of the scavenging pump. The gallery has access to an escape hole let into the body 121. This hole is formed into a valve seat, normally circular. A push rod end 122 is held in full contact with the valve seat by air pressure exerted through the air cylinder actuator. A suitable rod end is part-spherical. Any polymer pressure in excess of the valve seating pressure will cause the valve to lift from its seat. The system can be inter-locked with the extruder and Rheometer/Melt indexer to a fail safe system

In a further aspect of the invention, a rheometer function is recognised and achieved within an existing gear pump in a wider polymer process or control situation or environment. More specifically, the Applicant has achieved an ‘In-Process’ Rheometer function within a generic polymer gear pump extrusion line.

A generic polymer extrusion line used for duties such as the manufacture of polymer pipe, cast film, blown film and sundry other applications, frequently incorporates a gear pump. The role and duty of the gear pump is to accurately regulate the flow of polymer into the final stage of the extrusion line, in order to safely achieve consistent properties of the finished product, including the all important dimensional tolerances.

The gear pump also serves the purpose of isolation between the extruder stage and the final 50 stage of the line. The gear pump in such cases is normally equipped with pressure sensors at the inlet and outlet. The purpose of the pressure sensors is to as act pressure control devices as well as safety interlocks for over pressure conditions.

One or more deeply buried temperature probes are also made available to monitor and control the thermal condition of the gear pump body to the desired polymer line temperature. The extrusion line is normally equipped with a so-called ‘Supervisory Control and Data Acquisition SCADA)’ system and a ‘Man Machine Interface (MMI)’. Additionally some form of external measurement is used in certain functions concerning product certification, quality control and process control of the final product.

In small scale lines, an external measurement will be a laboratory based manual device, as the cost of a reliable line mounted device is too expensive. Usually laboratory based measurement will take the form of a rheometer; a Melt Flow Indexer for polymers such as Polyethylene, Polystyrene and Polypropylene etc.; or a Solution Viscometer measuring Intrinsic Viscosity for PET polymers etc. The external measurement can be made on samples taken from the finished product. There is an unfulfilled gap of an In-Process rheometer.

It is generally accepted that a polymer extrusion line is equipped to be its own In-Process (general-purpose) rheometer. For instance, it is common practice to use the extruder screw as a crude torque rheometer. A rheometer can also be realised by monitoring differential pressures at places other than the gear pump. The disadvantages of this approach are that the temperature profile and/or the rheometer Die can become indeterminate, due to variability caused by ambient conditions and any changes in the Die cross-section caused by polymer build up. Also additional sensors and interface would have to be provided.

At the gear pump block of the elements of the rheometer, in this case a Shear Viscometer, are readily identified in the equipment as described above. Differential pressure measurement, flow measurement, temperature measurement could be noted, but not the key component, the Die. The Die manifests itself when the flow through the pump is considered more closely. The pressure drop or rise across the pump is the resultant of two components.

In the first part the pressure differential is set by the individual conditions of the line (the extruder, the gear pump, the in-line mixer, the extrusion head and the interconnecting passageways). In the second part, the pressure loss is set by the shearing action on the polymer passing through the pump. The pump passageways are therefore acting as a conventional Die. It is a matter of isolating the second component of pressure drop from the first in a precise manner. When the Gear Pump, the Instrumentation and the SCADA system are put to this alternative or supplementary use, the combined elements become a part of another agenda—the realisation of a viable rheometer.

In a narrower context the In-Process Rheometer is a Shear Viscometer.

The governing relationship of the Die in a Shear Viscometer can be stated as follows:

Apparent Shear Viscosity=Shear Stress/Apparent Shear Rate equation (1)

The invention concerns the process of recognition of the In-Process Rheometer and the extraction of a meaningful and accurate representation of Shear Viscosity, Intrinsic Viscosity or Melt Flow Index from the instrumentation normally incorporated with the control system of the gear pump. Principal features include a driven gear 15-1, an idler Gear 15.2, a gear pump body 15-3, a device 15.4 for measurement of Temperature of molten polymer, a device 15.5 for measurement of Inlet pressure of molten polymer, a device 15.6 for measurement of Outlet pressure of molten polymer, an inlet passageway 15.7, an outlet passageway 15.8, a stream 15.9 of molten polymer ex-filter pack, ex-extruder, a stream 15.10 of molten polymer on way to final (film) stage, a SCADA system 15.11 in communication with extrusion apparatus and external networks.

FIGS. 15A and 15B shows a typical gear pump station. A flow path 15.7, 15.8 through a gear pump 15.1/2 can be considered to act a Die, as the inlet molten fluid polymer 15.9 will be deformed in shear as it passes through the pump 15.1/2.

Equation 1 can therefore be re-defined in terms of an Equivalent Capillary Die, to produce the component equations (2) and (3) as shown below, as well as 1 final Equivalent Capillary Die Viscometer in equation (4).

The same logic can be applied to define an Equivalent Slit Die Viscometer, an Equivalent Annular Die Viscometer, an Equivalent Rotational Viscometer, or other shear deformation Viscometer apparatus.

$$Shear Stress = Pressure Drop \times \frac{Equivalent Radius of die tract}{Equivalent Length of die tract} \qquad equation ( 2 )$$

$$Apparent Shear Rate = \frac{4 \times Flow Rate of flow through capillary}{Pi \times {( Equivalent Radius of capillary )}^{3}} \qquad equation ( 3 )$$

If the Equivalent dimensions of the capillary remain invariant, the Apparent Shear Viscosity can be expressed as:

$$Apparent Shear Viscosity = \frac{Flow Rate}{Differential Pressure} \times K \qquad equation ( 4 )$$

The Absolute of Differential Pressure is used to allow for the cases of pressure drop or pressure rise from inlet to outlet of the pump. K is the constant of proportionality

The elements or components and their arrangement depicted will therefore act as a Shear Viscometer. The SCADA system can be used to perform the operations of equation (4) and to display the Results on a local Man Machine Interface (MMI). The Results may be the Apparent Shear Viscosity or any result, such as Melt Index or Intrinsic Viscosity, that can be derived by the programme in the SCADA system 15.11.

The SCADA system 15.11 can be used to calculate and calibrate the Result values, as well as to re-transmit the Result values to any data management system connected by a means of communications, such as a LAN system.

Flow Rate

The gear pump 15.1/2 is a precision metering device, capable of maintaining a specific Flow Rate at a given rotational rate of the driven gear shaft, typically 92.6 cc/rev/sec.+/−0.1%.

Differential Pressure

The pressure drop across the pump 15.1/2 can be measured by the two liquid pressure transducers 15.5, 15.6, mounted respectively at the inlet and outlet of the gear pump 15.1/2, and in communication with the molten polymer. These devices 15.5, 15.6, are usually supplied as process monitoring tools for an extrusion line. Advantage can be taken of the pressure transducer stabilisation programme referred to before.

Isolation of Differential Pressure Due to the Shear in the Gear Pump

The two components contributing to the pressure differential of the pump 15.1/2 can be assumed to be additive. The pressure differential due to the shear action in the gear pump 15.1/2 can be isolated by systematic adjustments the extruder and the gear pump operating conditions. These adjustments enable correlations to be established and thus apportionment of the two differential pressure components. A Calibration section below describes and refines the use of correlations.

Temperature

Viscosity is very temperature dependent. A typical temperature coefficient is −3%/Degree Celsius. A typical extrusion line is designed to maintain extremely steady molten polymer temperature profiles along the entirely length of the line. The temperature probe 15.4 shown is placed to be substantially independent of ambient temperature and in close communication with the molten polymer stream passing through the gear pump 15.1/2. Advantage can be taken of the measurement of polymer Melt temperature, as referred to earlier.

Precision and repeatability are key to any benefit gained from improved plant productivity and/or product quality.

Calibration

The constant K can be found by cross-calibration against the appropriate standard apparatus. This process is complex, because the constant K is in fact a transform between the principal measurement relationships of the In-Process Rheometer and the chosen standard reference apparatus. The K factor also allows the Shear Viscometer to act in any functional capacity within the ambit of an In-Process Rheometer.

Unsurprisingly, cross-calibration can be very accurate, as well as unambiguous, when the relationships between the reference system and the Gear Pump Viscometer are performed through a look-up (transformation) curve, rather than any mathematical expression.

It is essential to limit errors, by keeping to rigid process operating conditions, particularly temperature of polymer. The target extrusion lines are dedicated to process a narrow range of polymer types and the sample used in the measurement is taken in real-time, making the new system a ‘Best Practice’ tool for process control and quality assurance alike.

Additional key benefits of the measurement technique are:
physical robustness of the measurement apparatus,
(by using equipment of well-proven core reliability, as opposed to process rheometers that are essentially a retrospective add-on to the process line); and minimal cost,
(making an extra use of existing equipment, which is provided as standard).
A Laboratory rheometer measurement is normally retained, as it becomes a trustworthy means to ensure compliance of Result and the Standardisation of the In-Process Rheometer.

Components
A Seepage
B Delivery chamber
C Taper
D Die entry
E Convergent compensation
F True capillary
G Divergent compensation
H Die exit
I Extrudate draw down
J Exit chamber
21 Piston
22 Piston tip
23 Heated barrel
24 Die
25 Extrudate
31 Sampled delivery chamber
32 Die block
33 Die inlet pressure transducer
34 Die inlet taper
35 Die
36 Extrudate
41 Sample delivery chamber
42 Die block
43 Die inlet pressure transducer
44 Die inlet taper
45 Die
46 Extrudate
51 Sample delivery chamber
52 Die block
53 Die inlet pressure transducer
54 Die inlet taper
55 Die
56 Sample exit chamber
57 Exit pressure transducer
61 Sample delivery chamber
62 Die block
63 Due inlet pressure transducer
64 Die inlet taper
65 Die
67 Edge transition
68 Entry angle
69 Passageway
60 Hexagon form
71 PT100 temperature probe
72 PT100 temperature probe
73 PT100 temperature probe
74 PT100 temperature probe
75 Electrically heated die block
76 Die chamber
77 Hatched area showing extent of PT100 sense element
78 Cartridge heater
79 Polymer extrudate at exit of die
70 Temporary die
81 Heated enclosure for a gauge section of pressure transducer controlled at 60-70° C.
82 Gauge section of rigid stem pressure transducer
83 Temperature-controlled heat sink running at 30-40° C.
84 Conduction block joining pressure transducer stem to heat pipe
85 Ceramic foam or similar insulator for pressure transducer stem
86 Heat Pipe
87 Ceramic foam or similar insulator for centre section of heat pipe
88 Optional fan
89 Rigid stem section of pressure transducer
80 Diaphragm sensing polymer melt pressure relative to atmosphere
811 Temperature controlled die block operating at test temperature, typically between 190-310° C.
91 Heated enclosure for a gauge section of pressure transducer controlled at 60-70° C.
92 Gauge section of rigid stem pressure transducer
93 Temperature-controlled heat sink running at 30-40° C.
94 Conduction block joining pressure transducer stem to heat pipe
95 Ceramic foam or similar insulator for pressure transducer stem
96 Heat Pipe
97 Ceramic foam or similar insulator for centre section of heat pipe
98 Optional fan
99 Rigid stem section of pressure transducer
90 Diaphragm sensing polymer melt pressure relative to atmosphere
911 Temperature controlled die block operating at test temperature, typically between 190-310° C.
101 Optional attachment frame
102 Extrudate feed tube and top cover
103 Rapid acting air cylinder with guided piston rod (one of two)
104 Cutter (one of two)
105 Safety cage with extrude slot at lower extremity
121 Return to stream Rheometer/Melt Indexer body
122 Push rod with ball end
123 Air cylinder actuator
15.1 driven gear
15.2 idler gear
15.3 gear pump body
15.4 temperature measurement device of molten polymer
15.5 inlet pressure measurement device of molten polymer
15.6 outlet pressure measurement device of molten polymer
15.7 inlet passageway
15.8 outlet passageway
15.9 molten polymer stream, ex-tilter pack, ex extruder
15.10 molten polymer stream on way to final (eg film) process stage
15.11 SCADA system in communication with extrusion apparatus and external networks

### APPENDIX 1

Contents
Summary
Preamble
Melt Flow Index apparatus
Replicate Melt Flow Index dies and accompanying rheology dies
   Computerised fluid dynamics
   Cluster Die
   Classification of MFI die systems
   Examples of a replicate MFI die and its rheology counterpart
Pressure transducer stabilisation
Gear pump range improvement
Temperature measurement in a molten polymer stream
Extrudate cutter
Pressure relief valve
Tables
Appendix 1
Appendix 2
Abstract
Figures

### APPENDIX 2

As a test bed for experimental and design work, an otherwise standard dual-die version of a proprietary Porpoise P5⁶ originally devised by the Applicant, was adopted, but improved in four areas, to serve as a high capability test bed for dies developed in Computerised Fluid Dynamics (CFD) investigations. A two-way valve diverts the total flow of polymer from a gear pump to either of two die chambers; each equipped with a melt pressure transducer to monitor the pressure across the die. Each die chamber has an individual die.

Flow behaviour calculations apply only to die systems from which the data was derived and the flow model adopted². With this approach it is necessary to replicate the sum of individual pressure drops in particular configurations of gear pump apparatus. With a return-to-stream, extruder-mounted rheometer, the die exit is flooded, which produces its own special pressure conditions. However, it is possible to operate this type with negligible variation in die exit pressure conditions.

For temperature-conditioning and melt temperature monitoring, the heating system is revised to remove a known cold spot, enabling a controllable supply of molten polymer in the die at the required MFI test temperatures (within 0.1° C. of 190, 200, 230° C. etc.). The measurement of polymer melt pressure is improved using some of the techniques described elsewhere.

FIG. 10 shows calibration graph of a P5 Melt Indexer, using a die of 3 mm capillary diameter, L/D ratio of 3.818:1 and 15 mm entry. FN=50 (log 10(MFI+1). Upper and lower bands shown are set at +/−30%

TABLE
FIG. 1

| | Category | | | |
|---|---|---|---|---|
| | | Single | Dual orifice | Single Orifice |
| | Std | non-return | non-return | return |
| | MFI | to stream | to stream | to stream |
| Drawing | FIG. 2 | FIG. 3 | FIG. 4 | FIG. 5 |
| Die region | | | | |
| Seepage | A | — | — | — |
| Delivery Chamber | B | B | B | B |
| Taper | — | C | C | C |
| Die entry | D | D | D | D |
| Convergent | — | E | E | E |
| compensation | | | | |
| True capillary | F | F | F | F |
| Divergent | — | G | G | G |
| compensation | | | | |
| Die exit | H | H | H | H |
| Extrudate draw | I | I | I | — |
| down | | | | |
| Exit chamber | — | — | — | J |
| Component | | | | |
| Part Nos | | | | |
| Piston | 21 | — | — | — |
| Piston Tip | 22 | — | — | — |
| Heated Barrel | 23 | — | — | — |
| Sample Delivery | — | 31 | 41 | 51 |
| Chamber | | | | |
| Die Block | — | 32 | 42 | 52 |
| Die | 24 | 35 | 45 | 55 |
| Die Inlet Taper | — | 34 | 44 | 54 |
| Die Inlet | — | 33 | 43 | 53 |
| Pressure | | | | |
| Transducer | | | | |
| Exit Pressure | — | — | — | 57 |
| Transducer | | | | |
| Extrudate | 25 | 36 | 46 | — |
| Sample Exit | — | — | — | 56 or 58 |
| Chamber | | | | |

1-27. (canceled)

28. A rheometer aligned with, calibrated or otherwise standardised to a prescribed rheological measurement reference variously by a so-called ‘Cluster Die’, with one or more die orifices matched to a standard Melt Flow Index Die for equivalent rheological effect; including an orifice matched to a standard Melt Flow Index Die to produce both a multiplier pressure drop and equivalent overall rheological effect, along with individual regional adjustments or combined regional adjustments of die and/or die environment, and a slow matching taper of die and/or die environment to conjoin two flow regions with minimal interference in flow pattern or pressure drop.

29. The rheometer of claim 28, with a thermometer placement in the body surrounds of a heated die to measure die melt temperature, with a thermometer for die melt temperature calibrated by temporary and permanent placement of other thermometers in the die melt, in the die and at the die heating element(s) and a temperature stabilisation device for melt pressure transducers of rigid or flexible stem construction, of any type of pressure transducer.

30. The rheometer of claim 28, standardised to a prescribed rheological measurement reference variously by any or all of the following features or characteristics:
a so-called ‘Cluster Die’, with one or more die orifices matched to a standard Melt Flow Index Die for equivalent rheological effect;
an orifice matched to a standard Melt Flow Index Die to produce both a multiplier pressure drop and equivalent overall rheological effect;
individual regional adjustments or combined regional adjustments;
a slow matching taper of die and/or die environment to conjoin two flow regions with minimal interference in flow pattern or pressure drop;
thermometer placement in the body surrounds of a heated die to measure die melt temperature;
a thermometer for die melt temperature calibrated by temporary and permanent placement of other thermometers in the die melt, in the die and at the die heating element(s);
a temperature stabilisation device for melt pressure transducers of rigid or flexible stem construction, of any type of pressure transducer.

31. The rheometer of claim 28, with complementary measurement chamber, internal die profile, disposition, transition pathway, entry and exit profiles, within temperature-conditioned confines and with embedded thermometer and pressure sensor, fitted with a ‘replicate die’, individually or as part of a die group and termed a ‘Cluster Die’, to replicate a rheological test, such as a Melt Flow Index test, with delivery and exit chamber regions configured to define the rheological test, using a die with one or more orifices.

32. The rheometer of claim 31, with a Cluster Die connected to a positive displacement device, such as single gear pump or piston in bore, fitted in a twin bore rheometer, of a capillary diameter, entry chamber diameter or exit chamber diameter, in which all orifices share, and therefore have interactive entrance and exit effects respectively with delivery and exit chamber regions, with a Cluster Die using compensation by the adjustment of dimensions of an individual or a collection of regions to mimic of the total or overall characteristic of a standard test die, using any number of regions as necessary, such as a non-circular cross-section or taper in any of the regions.

33. The rheometer of claim 28, fitted with a relief valve that actuates below a pressure transducer(s) service limit, enabling risk-free deployment of pressure transducers with a low pressure span, with a relief valve operable as a means of de-pressurisation to establish an accurate zero ambient pressure point, as a key part of system calibration.

34. The rheometer or melt indexer, of claim 28, in a return-to-stream configuration with an extruder, with a gear pump connected to deliver polymer back to an extruder, acting as a scavenge pump, normally run, say at 2-3 bar, above ambient; a body with a gallery connecting the or each die exit to the entry of the scavenging pump and with access to an escape hole let into the body formed into a valve seat, normally circular; a push rod end, such as a part sphere, held in full contact with the valve seat by air pressure exerted through an air cylinder actuator; whereby any polymer pressure in excess of the valve seating pressure will cause the valve to lift from its seat; allowing an option of inter-lock with the extruder as a fail-safe system.

35. The rheometer of claim 28, with means for maintaining a desired thermal environment around a diaphragm, capillary and strain gauge chamber, using a plurality, such as up to three, temperature-controlled zones, isolated from ambient by insulating blanket materials, with pressure transducer stabilisation by creating two rigidly-controlled temperature zones at a sensing diaphragm and a gauge; a longitudinal or lateral heat pipe operable to divert heat flux from a die block, which would otherwise overcome the gauge temperature control zone regulation, so excess heat flux is dissipated in an offset or outboard heat sink; with an optional fan operable at high ambient temperatures; insulators disposed to reduce perturbation of the ambient temperature variation.

36. The rheometer of claim 28, with an automatic extrudate cutter, configured to chop or sever the extrudate close to the die exit, with two cutters are close together, with their edges almost touching, thus severing the extrudate stream(s); cutting blade travel being sufficient, say 25 mm, to allow good clearance of the extrudate as it is formed; the cutter blades being of hardened steel; the blades being of a sufficient thermal mass to prevent adhesion of the semi-molten polymer, when operated at approximately 20 cuts/minute; the extrude dropping through a slot in the bottom of a safety cover; the slot being dimensioned and positioned to prevent inadvertent entry of a human hand; as a safety shut-down or permissive run interlock, the equipment being fitted with an intrusion sensor, which also acts as a blockage detector.

37. The rheometer of claim 28, with a reference thermometer placement in structure surrounding a die tract, for temperature measurement of the liquid passing through the die, with multiple sensing probes distributed over a die block, such as probes positioned on a radial plane of the die block, itself electrically heated by cartridge or band heaters to provide a near uniform temperature zone; one probe being used to control the block to a specified test temperature, another probe acting as a permanent molten polymer temperature probe; with a die block and die specially modified for system calibration by using two test thermometers, one in a blind hole in the die, through an entry hole in the die block proper, another entering the die at a position normally taken by a pressure transducer; re-positioned to measure temperature at various positions along the die axis; by monitoring those multiple, say four, temperatures under varying conditions of melt feed and die temperature, to establish relationships between probes.

38. The rheometer of claim 28, with a polymer metering gear pump melt delivery system configured to regulate polymer pressure at gear pump entry, and controlled at a pressure related to the speed of a pump drive motor, comprising a ram intensifier to feed a gear pump through a static melter under compressed air from either of two air lines, set at respective prescribed thresholds, such as at 5 bar for a flow rate at or above 0.3 g/min and 0.5 bar for a flow rate below 0.3 g/min, with a die suite for replicating a range of rheological tests, alongside, in relation to, or juxtaposed with a MFI test.

39. The rheometer of claim 28, with a polymer metering gear pump melt delivery system, configured to regulate the pressure at the gear pump entry, and controlled at a pressure related to the speed of a pump drive motor, comprising a valve structure used to regulate the inlet pressure to the gear pump entry at a controlled pressure of say 25 bar, when the flow rate is below 0.3 gm/minute.

40. The rheometer of claim 28, with a plurality of dies in a die group or cluster including a die calibrated to a reference standard such as Melt Flow Index configured to allow parallel correlated test of a common polymer melt stream.

41. The rheometer of claim 28, using an existing gear pump, a rheometer adaptation of a gear pump, or elements thereof, with a flow path restriction through the gear pump serving as a die, as polymer melt fluid will be deformed in shear as it passes through the pump; with allowance for gear pump drive motor torque at target drive speed considerations.

42. The rheometer of claim 28, with die orifices in respective individual, common or shared die blocks.

43. A rheometer with multiple discrete dies, or die orifices in individual or shared die bodies, set within a common conditioning environment, configured for conducting different tests in parallel, through respective dies, with test conditions, including temperature and pressure, appropriate for each test and with multi-test ‘parallel’ or harmonised outcomes for a more complete assessment than any individual test, even a prime measure such as MFI, taken in isolation; with MFI remaining an invaluable part of a wider test spectrum since the other tests can be related to an MFI determination, albeit at each MFI test condition; the rheometer having refinements of which two involve capillary die geometry, and reflecting
a simple and direct means of more accurate replication of important elements, factors or influences of Melt Flow Index flow conditions;
standardisation, harmonisation or conformity of a so-called ‘multi-shear’ rheometer measurement or test with a Melt Flow Index measurement or test, in a common conditioning environment, to allow test inter-relationship;
precise pressure measurement in a polymer melt, using appropriate sensors such as conventional liquid-filled sensors; reflecting rheometer reliance upon difficult measurement of polymer melt pressure;
gear pump volumetric efficiency improvement at low flow rates for driving a sample through the dies;
improved polymer temperature conditioning.

44. A rheometer configured for rheometric measurement for a range of materials using a range of different die profiles and dimensions, along with different test chamber through flow rates, and a range of gear pump speeds or capacities to drive material through the dies; with a so-called ‘replicate’ die profile, configuration, context and environment, together with environmental conditioning, of temperature and/or pressure, and a set of dies covering a measurement range or spectrum as a replicate group or cluster including an MFI die; whereby overall, the rheometer, or an isolated rheometer portion or test stream, is standardised to a prescribed rheological measurement reference standard, of which MFI is a prime example, variously with one or more of the following features:
a so-called ‘Cluster Die’, with one or more die orifices ‘matched’ to a standard Melt Flow Index Die, for equivalent or replicate rheological effect;
an orifice matched to a standard Melt Flow Index Die, to produce both a ‘multiplier’ pressure drop and equivalent overall rheological effect;
individual regional adjustment(s), or combined regional adjustment(s);
a slow, ‘matching’ taper to conjoin two flow regions, with minimal interference of flow pattern or pressure drop;
thermometer placement in the body surrounds of a heated die, to measure die melt temperature;
calibration or cross-referral of a thermometer for die melt temperature by temporary and/or permanent placement of other thermometers in the die melt, in the die and at the heating element(s) of the die;
a temperature stabilisation device for melt pressure transducers of rigid or flexible stem construction, of any type of pressure transducer;
the dies being disposed in a common and complementary measurement chamber, internal die disposition, transition pathway, entry and exit profiles, within temperature-conditioned confines and with embedded thermometer and pressure sensor.

45. The rheometer of claim 44, with dies set in a common test chamber with a divided or apportioned sample streams with an interactive effect upon flows, taken into account for parallel tests and/or test chamber sub-division, with dedicated sub-chambers for each die, for isolated tests in a common conditioned environment, in an enshrouding die block with attendant heaters, temperature and pressure sensors.

46. The rheometer of claim 44, with a particular version or expression of a so-called ‘replicate die’ termed a ‘Cluster Die’, as a means to replicate a target rheological test, such as, but not limited to, a Melt Flow Index test and features a delivery chamber region and an exit chamber region, to define any rheological test employing a die with one or more orifices disposed in a group or ‘cluster’, these orifices being in a shared body or housing or respective individual bodies and connected to a positive displacement device, such as single gear pump or piston in bore, as in a twin bore rheometer and using elements of an existing gear pump for this purpose, whilst those elements retain their original purpose, with a die orifice internal and bounding, communication or access profiles may have a significant ‘interactive’ effect upon measurement conducted using the die; and whirring any capillary diameter, entry chamber diameter or exit chamber diameter may be employed; all orifices share, and therefore have interactive entrance/exit effects with, the delivery/exit chamber regions; a cluster die can use so-called ‘Compensation’ by adjustment of dimensions of an individual or a collection of regions to enable mimic or emulation of the total characteristic of a standard test die, such Compensation can use any number of regions, as needed, and can take the form of a non-circular cross-section or taper in any of the regions.

47. The rheometer of claim 43, with either or both of two classes of Cluster Die respectively defined as on the one hand a so-called ‘normal die’ which exhibits a nominal pressure drop equivalent to that of a so-called ‘standard die’ which it replicates, examples being single orifice MFI die or a dual orifice MFI die which is rheologically equivalent to two dies operating in parallel to achieve accurate MFI measurement of very high molecular weight polymers, such as high density polyethylene (HDPE) at low test weight conditions, the shape and orientation of transition regions between die entry chamber and die entries being adjusted to ensure equal or near equal flow rates through each individual capillary section; and on the other hand a so-called ‘rheology die’ accompanying a normal die of MFI type to make a rheology set or ‘suite’ of dies, of which more than one rheology die can be used and any rheology die can be a MFI die, the suite of dies having differing capillary diameters for an entry pressure drop nearly independent of the capillary diameter; to ensure that all rheological characteristics are accurately referenced to an MFI standard, and also have the capability to derive accurate Shear Viscosity, as a function of shear rate, etc, over a very wide range, to give ready access to polymer structure ‘assays’, such as Molecular Weight Distribution.
